(19) United States
(12) Patent Application Publication
(10) Pub. No.: US 2009/0038116 A1
(43) Pub. Date: Feb. 12, 2009

(54) HINGE ASSEMBLY

(75) Inventors: Jia-Hao Hsu, Shulin City (TW); Ting-Hsien Wang, Shulin City (TW)

Correspondence Address: PAI PATENT & TRADEMARK LAW FIRM, 1001 FOURTH AVENUE, SUITE 3200, SEATTLE, WA, 98154, US

(73) Assignee: SHIN ZU SHING CO., LTD., Shulin City (TW)

(21) Appl. No.: 11/837,533

(22) Filed: Aug. 12, 2007

(51) Int. Cl. E05D 7/04

(52) U.S. Cl. 16/240

(57) ABSTRACT

A hinge assembly attaches a cover pivotally to a base of an electronic device and has a pivoting leaf and a stationary leaf. The pivoting leaf is mounted in the cover and has a shaft. The stationary leaf is mounted rotatably around the pivoting leaf, is mounted in the base to allow the cover to pivot relative to the base and has a barrel. The barrel is tightly mounted rotatably around the shaft and has a gudgeon and a slit. The gudgeon is formed coaxially through the barrel. The slit is formed longitudinally through the barrel and communicates with the gudgeon and allows the barrel to expand to fit the shaft. Having the barrel with the slit reduces the size of the hinge assembly so the hinge assembly allows electronic devices to be smaller and thinner.

### BACKGROUND OF THE INVENTION

1. Field of the Invention

The present invention relates to a hinge assembly, and more particularly to a hinge assembly to attach a cover pivotally to a base of an electronic device.

2. Description of Prior Art

With reference to FIGS. 6 and 7, electronic devices such as notebooks (60) have a cover (62), a base (61) and a conventional hinge. The conventional hinge pivotally connects the cover (62) to the base (61) and provides friction to hold the cover in a variety of desired positions relative to the base (61).

The conventional hinge comprises a stationary leaf (51), a bushing (52) and a pivoting leaf (53).

The stationary leaf (51) is attached securely in the base (61) and has a distal end, a bottom, a mounting segment (511), a through hole (512) and a slot (513). The mounting segment (511) is formed on the bottom and extends into and mounts securely in the base (61). The through hole (512) is formed in the distal end of the stationary leaf (51) and has an inner surface. The slot (513) is formed longitudinally in the inner surface of the through hole (512).

The bushing (52) is mounted tightly in the through hole (512) and has two ends, an outside surface, a gudgeon, a slit (521) and a neck (522). The gudgeon is formed coaxially through the bushing (52). The slit (521) is formed longitudinally through the outside surface between the two ends, communicates with the gudgeon and is expandable. The neck (522) is formed longitudinally on the outside surface between the two ends and engages the slot (513) to securely mount the bushing (52) inside the through hole (512) of the stationary leaf (51).

The pivoting leaf (53) is tightly mounted pivotally through the gudgeon of the bushing (52), causing the slit to expand and hold the hinge together tightly, is mounted securely in the cover (62) to allow the cover (62) to pivot relative to the base (61) and has a proximal end, a distal end, a mounting segment (531) and a pintle (532). The mounting segment (531) is formed on the distal end of the pivoting leaf (53) and attaches securely to the cover (61) to mount the pivoting leaf (53) on the cover (61). The pintle (532) is formed on the proximal end of the pivoting leaf (53) and is tightly mounted pivotally through the gudgeon of the bushing (52).

However, electronic devices are designed smaller, thinner and lighter for convenience. The bushing (52) with a neck prevents further downscaling and weight reduction. This in turn limits how thin the hinge and consequently the electronic device may be and raise the material costs for manufacture.

To overcome the shortcomings, the present invention provides a hinge assembly to mitigate or obviate the aforementioned problems.

### SUMMARY OF THE INVENTION

The primary objective of the present invention is to provide a hinge assembly that uses less material so is smaller and lighter to allow downscaling of an electronic device connected pivotally using the hinge.

The hinge assembly attaches a cover pivotally to a base of the electronic device and has a pivoting leaf and a stationary leaf. The pivoting leaf is mounted in the cover and has a shaft. The stationary leaf is mounted rotatably around the pivoting leaf, is mounted in the base to allow the cover to pivot relative to the base and has a barrel. The barrel is tightly mounted rotatably around the shaft and has a gudgeon and a slit. The gudgeon is formed coaxially through the barrel. The slit is formed longitudinally through the barrel and communicates with the gudgeon and allows the barrel to expand to fit the shaft. Having the barrel with the slit reduces the size of the hinge assembly so the hinge assembly allows electronic devices to be smaller and thinner.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a hinge assembly in accordance with the present invention;

FIG. 2 is a perspective view of the hinge assembly in FIG. 1;

FIG. 3 is a bottom view of the hinge assembly in FIG. 1;

FIG. 4 is a side view in partial section of the hinge assembly in FIG. 1 mounted in a notebook;

FIG. 5 is a side view in partial section of the hinge assembly in FIG. 1 mounted in a notebook;

FIG. 6 is an exploded perspective view of a conventional hinge in accordance with the prior art; and

FIG. 7 is a side view of the conventional hinge in FIG. 6 mounted in a notebook.

### DETAILED DESCRIPTION OF THE PREFERRED EMBODIMENTS

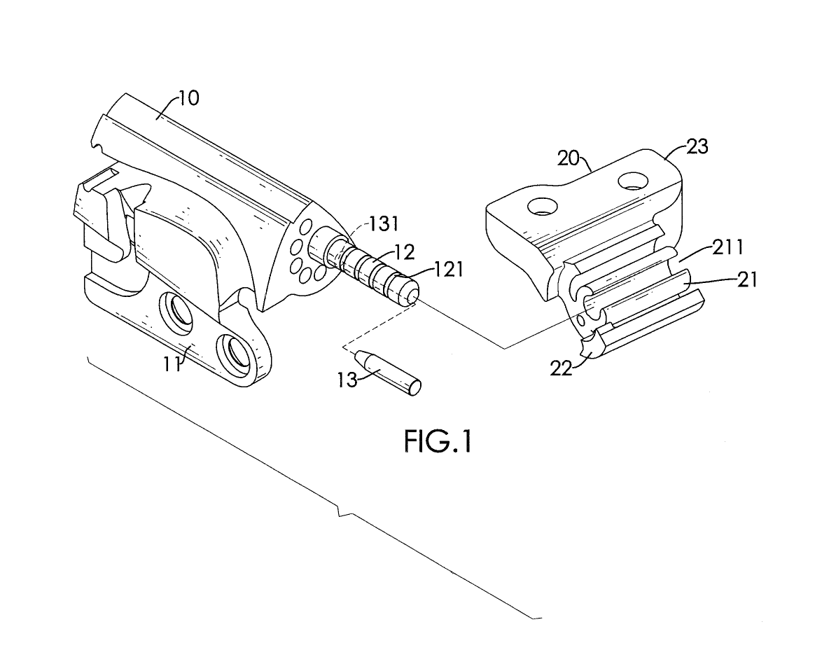

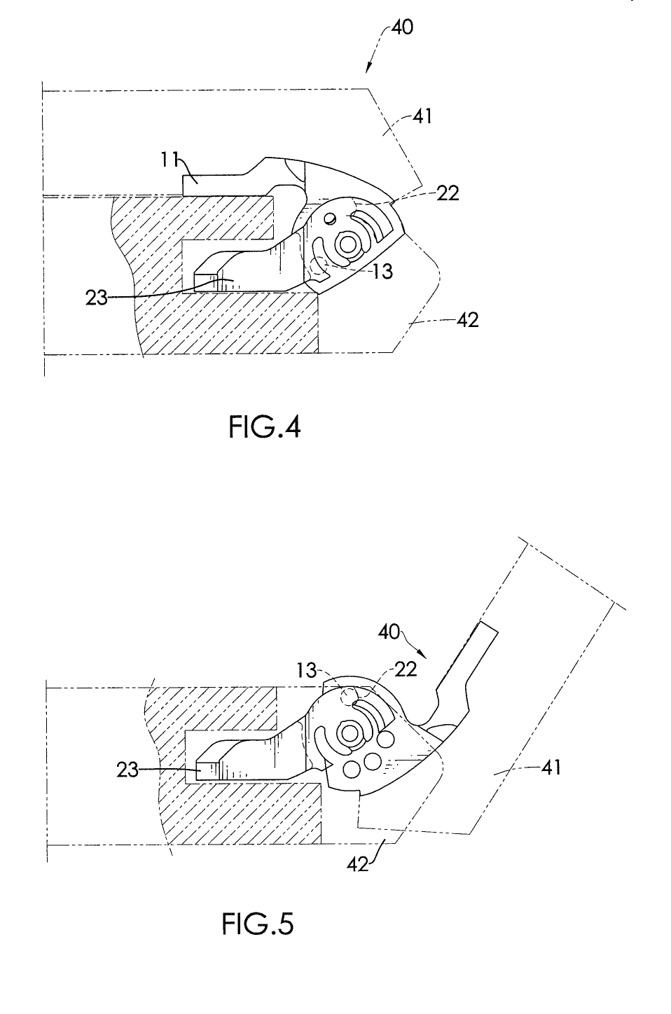

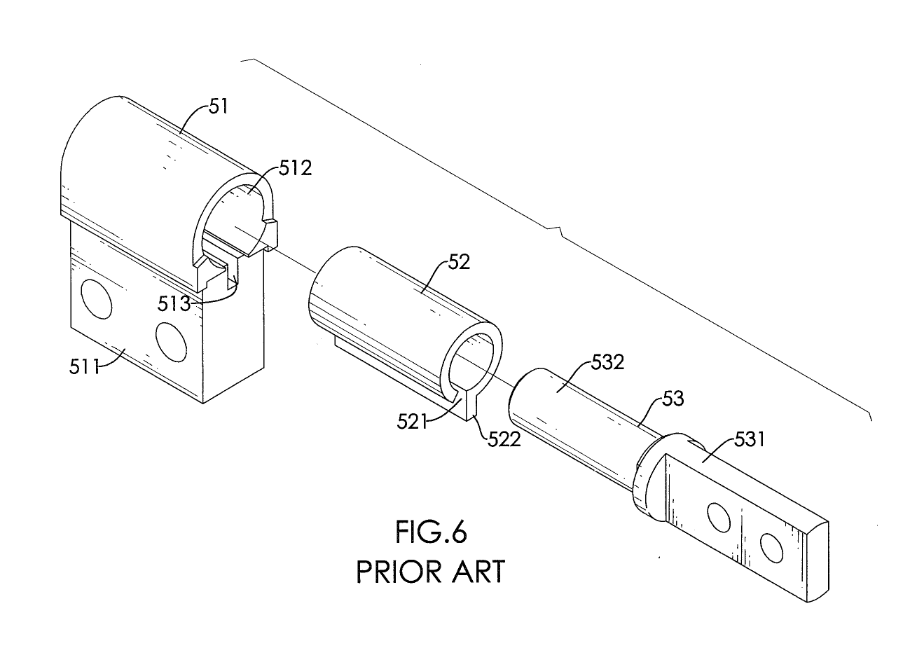

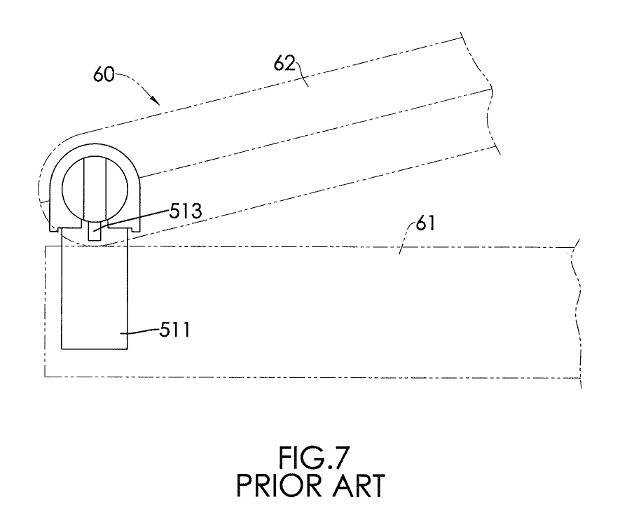

With reference to FIGS. 1 and 4, a hinge assembly in accordance with the present invention attaches a cover (41) pivotally to a base (42) of an electronic device such as a notebook (40) and comprises a pivoting leaf (10) and a stationary leaf (20).

The pivoting leaf (10) is mounted securely in the cover (41) and has a mounting segment (11), a shaft (12), an optional limit mount (131) and a limit (13).

The mounting segment (11) is connected securely with the cover (41), has a pivoting end and may have multiple mounting holes. The mounting holes are formed through the mounting segment (11).

The shaft (12) is formed coaxially on and extends from the pivoting end of the mounting segment (11) and has a distal end, an outside wall and may have at least one oil-groove (121). The oil-groove (121) is formed around the outside wall of the shaft (12) and allows a lubricant to be added.

The limit mount (131) is formed in the pivoting end of the mounting segment (11) near the shaft (12).

The limit (13) is a rod, extends from the distal end of the mounting segment (11) and may be mounted securely in the limit mount (131).

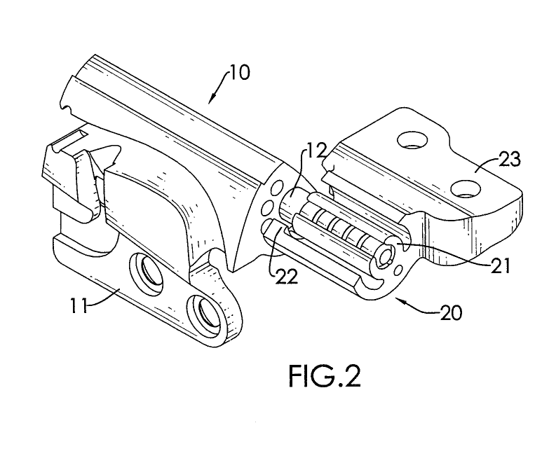

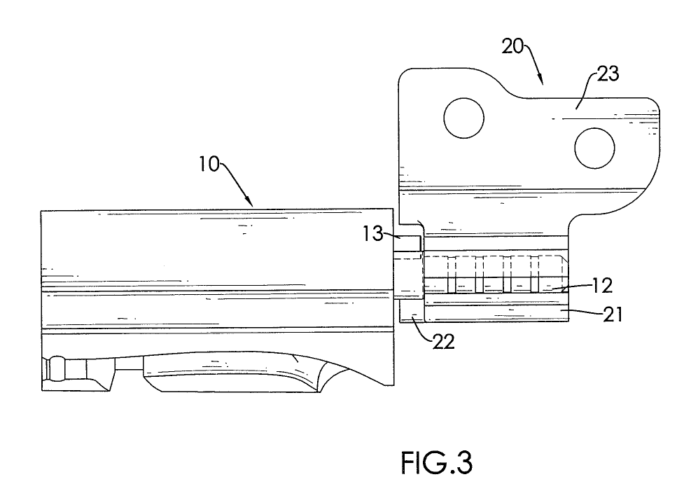

With further reference to FIGS. 2 and 3, the stationary leaf (20) is mounted rotatably around the shaft (12) of pivoting leaf (10), is mounted securely in the base (42) to allow the cover (41) to pivot relative to the base (42), may be curved and has two opposite sides, a pivoting end, a barrel (21), a limiting protrusion (22) and a mounting segment (23).

The barrel (21) is formed longitudinally between the two sides of the stationary leaf (20), is tightly mounted rotatably around the shaft (12) and has two ends, a gudgeon and a slit (211). The gudgeon is formed coaxially through the barrel (21) and tightly mounted rotatably around the shaft (12). The slit (211) is formed longitudinally through the ends of the barrel (21) and communicates with the gudgeon and allows the barrel (21) to expand to fit the shaft (12). The barrel (21) may be tapered toward the slit (211).

With further reference to FIG. 5, the limiting protrusion (22) is formed on and protrudes from the pivoting end of the stationary leaf (20), corresponds to and selectively abuts the limit (13) to limit rotation of the hinge assembly to provide the cover (41) a maximum open angle.

The mounting segment (23) is formed on one of the sides of the stationary leaf (20), is connected securely with the base (42) and may have multiple mounting holes. The mounting holes are formed through the mounting segment (23).

Therefore, having the barrel (21) with the slit (211) not only provides friction for the hinge but also prevents the hinge from being too tight. Furthermore, the size and the material cost of the hinge assembly are reduced due to the barrel (21) being formed directly on the stationary leaf (20). Consequently, the hinge assembly has lower material costs and allows electronic devices to be thinner and smaller.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge assembly comprising
a pivoting leaf having
a mounting segment having a pivoting end;
a shaft being formed coaxially on and extending from the pivoting end of the mounting segment and having
a distal end; and
an outside wall; and
a limit being a rod and extending from the distal end of the mounting segment; and
a stationary leaf being mounted rotatably around the shaft of the pivoting leaf and having
two opposite sides;
a pivoting end;
a barrel being formed longitudinally between the two sides of the stationary leaf, being tightly mounted rotatably around the shaft and having two ends;
a gudgeon being formed coaxially through the barrel and being tightly mounted rotatably around the shaft; and
a slit being formed longitudinally through the ends of the barrel and communicating with the gudgeon;
a limiting protrusion being formed on and protruding from the pivoting end of the stationary leaf, corresponding to and selectively abutting the limit; and
a mounting segment being formed on one of the sides of the stationary leaf.

2. The hinge assembly as claimed in claim 1, wherein the barrel is tapered toward the slit.

3. The hinge assembly as claimed in claim 1, wherein
the pivoting leaf further has a limit mount being formed in the pivoting end of the mounting segment near the shaft; and
the limit of the pivoting leaf is mounted in the limit mount of the pivoting leaf.

4. The hinge assembly as claimed in claim 1, wherein
the mounting segment of the pivoting leaf has multiple mounting holes being formed through the mounting segment of the pivoting leaf; and
the mounting segment of the stationary leaf has multiple mounting holes being formed through the mounting segment of the stationary leaf.

5. The hinge assembly as claimed in claim 1, wherein the shaft of the pivoting leaf further has at least one oil-groove being formed around the outside wall of the shaft.

6. The hinge assembly as claimed in claim 1, wherein the stationary leaf is curved.

7. The hinge assembly as claimed in claim 2, wherein
the pivoting leaf further has a limit mount being formed in the distal end of the pivoting leaf near the shaft; and
the limit of the pivoting leaf is inserted in and mounted in the limit mount.

8. The hinge assembly as claimed in claim 7, wherein
the mounting segment of the pivoting leaf has multiple mounting holes being formed through the mounting segment of the pivoting leaf; and
the mounting segment of the stationary leaf has multiple mounting holes being formed through the mounting segment of the stationary leaf.

9. The hinge assembly as claimed in claim 8, wherein the shaft of the pivoting leaf further has at least one oil-groove being formed around the outside wall of the shaft.

10. The hinge assembly as claimed in claim 9, wherein the stationary leaf is curved.
